(19) United States
(12) Patent Application Publication
(10) Pub. No.: US 2025/0264362 A1
(43) Pub. Date: Aug. 21, 2025

(54) COLOR MEASUREMENT METHOD, INFORMATION PROCESSING APPARATUS, COLOR VERIFICATION SYSTEM, AND MEDIUM

(71) Applicant: CANON KABUSHIKI KAISHA, Tokyo (JP)

(72) Inventor: TAKUMI URYU, Chiba (JP)

(21) Appl. No.: 19/051,106

(22) Filed: Feb. 11, 2025

(30) Foreign Application Priority Data
Feb. 16, 2024 (JP) 2024-022201

(51) Int. Cl. G01J 3/52; G01J 3/46

(52) U.S. Cl. CPC G01J 3/524; G01J 3/463

(57) ABSTRACT

An information processing apparatus performs, as a first specification processing, specification processing of specifying, in a color chart composed of a plurality of rows each including a plurality of color patches, one candidate row that is a candidate for a color-measured row in which a user performed color measurement, based on colorimetric values of the candidate row and reference values of respective color patches in the color chart; and performs specification processing of specifying, in a case where it is not possible to specify only one candidate row in the first specification processing, the color-measured row with use of information other than colorimetric values.

### BACKGROUND OF THE INVENTION

### Field of the Invention

The present invention relates to a color measurement method for measuring colors of a color chart, an information processing apparatus, a color verification system, and a medium.

### Description of the Related Art

As customers have high expectations for differences in shades of color in commercial printed materials, such as catalogs and pamphlets, color management is carried out for such commercial printed materials before printing. The color management includes, for example, color verification in which an output color chart is measured and an actual output result (measured values) is compared with set indicators (reference values). The color management also includes calibration that adjusts shades of color and color misregistration in a case where color printing does not produce desired shades of color.

To perform this color management, it is necessary to actually measure the color output status of an image forming apparatus by performing color measurement on a color chart output from the image forming apparatus with use of a colorimeter. A color chart is a printed material which is intended for checking the appropriateness of printing performed by the image forming apparatus, and which is a collection of various patterns of color mixtures of ink and toner and thicknesses of lines in the colors CMYK.

There is a conventional color measurement method in which, based on whether each of colorimetric values of a plurality of color patches arranged on one line is within a predetermined range relative to a reference value, it is determined whether the color patches for which color measurement has been performed are arranged on one line (e.g., see Japanese Patent Laid-Open No. 2015-152552).

However, according to the conventional technique, during color measurement in a row, a notification is provided to a user when the color measurement has been performed in another row due to shifting of a hand, and the user is caused to, before performing color measurement on a color chart, select a row in which the color measurement is to be performed with use of an input apparatus, such as a mouse. This requires the user's hand to switch between the input apparatus and the colorimeter each time color measurement in a row is performed, thereby impairing usability. In view of this, it may be possible to automatically determine in which row color measurement has been performed merely by performing color measurement on a color chart with use of the colorimeter without using the input apparatus. However, in a case where the same color patches are arranged in a plurality of rows in a color chart and it is difficult to determine in which row color measurement has been performed by a user, it is not possible to automatically determine a row.

### SUMMARY OF THE INVENTION

In view of the above, the present invention realizes color measurement without impairing, to the extent possible, convenience of a mechanism for making an automatic determination merely using a colorimeter, even in a case where it is difficult to specify one measured row.

The present invention is configured as follows. An aspect of the present invention provides an information processing apparatus, comprising:
at least one memory storing instructions; and
at least one processor that is in communication with the at least one memory and that, when executing the instructions, cooperates with the at least one memory to execute processing, the processing including
performing, as first specification processing, specification processing of specifying, in a color chart composed of a plurality of rows each including a plurality of color patches, one candidate row that is a candidate for a color-measured row in which a user performed color measurement, based on colorimetric values of the candidate row and reference values of respective color patches in the color chart, and
performing, as second specification processing, specification processing of, in a case where it is not possible to specify only one candidate row in the first specification processing, specifying the color-measured row with use of information other than colorimetric values.

Another aspect of the present invention provides a color verification system, comprising:
an information processing apparatus; and
an image forming apparatus,
wherein the information processing apparatus includes:
at least one memory storing instructions; and
at least one processor that is in communication with the at least one memory and that, when executing the instructions, cooperates with the at least one memory to execute processing, the processing including
   performing, as first specification processing, specification processing of specifying, in a color chart composed of a plurality of rows each including a plurality of color patches, one candidate row that is a candidate for a color-measured row in which a user performed color measurement, based on colorimetric values of the candidate row and reference values of respective color patches in the color chart, and
   performing, as second specification processing, specification processing of, in a case where it is not possible to specify only one candidate row in the first specification processing, specifying the color-measured row with use of information other than colorimetric values, and
color calibration is performed based on the color-measured row specified by the information processing apparatus, and on a color chart that has been formed as an image by the image forming apparatus.

According to the present invention, when performing color measurement on a color chart in which the same color patches are arranged, color measurement can be realized without impairing, to the extent possible, convenience of a mechanism for making an automatic determination merely using a colorimeter.

Further features of the present invention will become apparent from the following description of exemplary embodiments with reference to the attached drawings.

### BRIEF DESCRIPTION OF THE DRAWINGS

FIG. 1 is a block diagram showing an entirety of a color verification system according to a first embodiment.

FIG. 2 is a configuration diagram of hardware of an information processing apparatus according to the first embodiment.

FIG. 3 is a functional block diagram of the system according to the first embodiment.

FIG. 4 is a diagram showing examples of hardware of a colorimeter according to the first embodiment.

FIG. 5 is a diagram showing an example of a measurement screen according to the first embodiment.

FIG. 6 is a diagram showing examples of setting values according to the first embodiment.

FIG. 7A and FIG. 7B are diagrams showing examples of a matrix representation of reference values according to the first embodiment.

FIG. 8 is a diagram showing an example of a color chart according to the first embodiment.

FIG. 9 is a diagram showing examples of colorimetric values according to the first embodiment.

FIG. 10 is a diagram showing an example of a colorimetric result according to the first embodiment.

FIG. 11A and FIG. 11B are diagrams showing an example of a color measurement screen and a transition according to the first embodiment.

FIG. 12 is a flowchart for a case where color measurement is performed according to the first embodiment.

FIG. 13A and FIG. 13B are diagrams showing an example of a color measurement screen according to a second embodiment.

FIG. 14 is a flowchart for a case where color measurement is performed according to the second embodiment.

FIG. 15 is a flowchart of processing for performing color measurement and uniquely specifying a row according to the second embodiment.

FIG. 16 is a flowchart for a case where color measurement is performed according to a third embodiment.

FIG. 17 is a flowchart for a case where color measurement is performed using history information according to the third embodiment.

FIG. 18 is a flowchart for a case where color measurement is performed according to a fourth embodiment.

FIG. 19A and FIG. 19B are diagrams showing an example of a color measurement screen according to the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### <System Configuration>

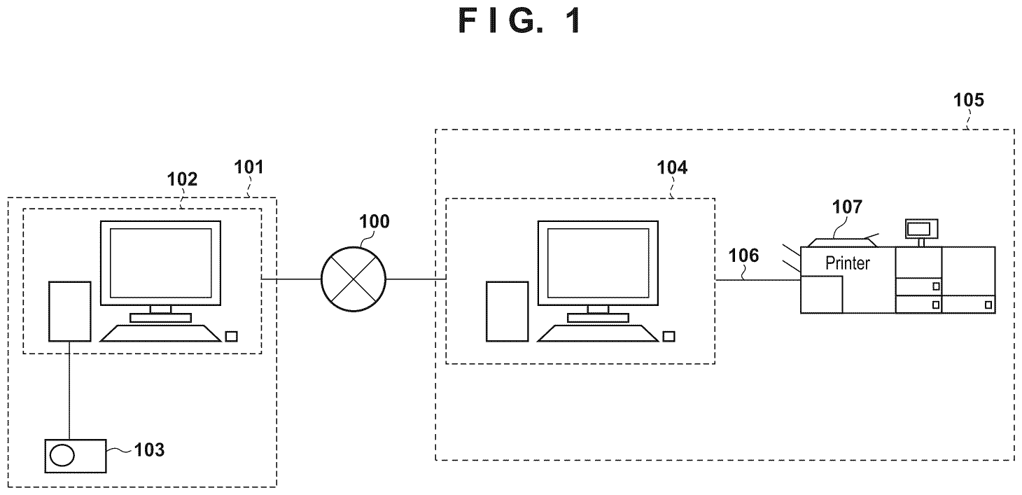

An image forming system, a color verification system, and hardware configurations related to the present embodiment will be described using a block diagram of FIG. 1. FIG. 1 is a block diagram showing a color verification system (or an image forming system) according to the present embodiment. The color verification system is broadly divided into a color measurement system 101 and a color management system 105, which are mutually connected via a network 100, such as the Internet.

The color measurement system 101 is composed of an information processing apparatus 102 and a colorimeter 103. It is assumed that an on-premises application operates on the information processing apparatus 102. Note that something other than the on-premises application may be used in the embodiment as long as the present invention can be realized. For example, a service or an application provided by a cloud server may execute processing that is the same as processing of the aforementioned application. The colorimeter 103 may be a manual colorimeter or an automatic colorimeter.

The color management system 105 includes an information processing apparatus 104 and an image forming apparatus 107 that are mutually connected via a network 106. An application that operates on the information processing apparatus 104 is mainly referred to as a print controller, and controls the image forming apparatus 107. The image forming apparatus 107 is controlled under a group of programs that operate on the information processing apparatus 104, processes print settings and print data accepted from the information processing apparatus 104, and generates a printed material.

### Hardware of Information Processing Apparatuses

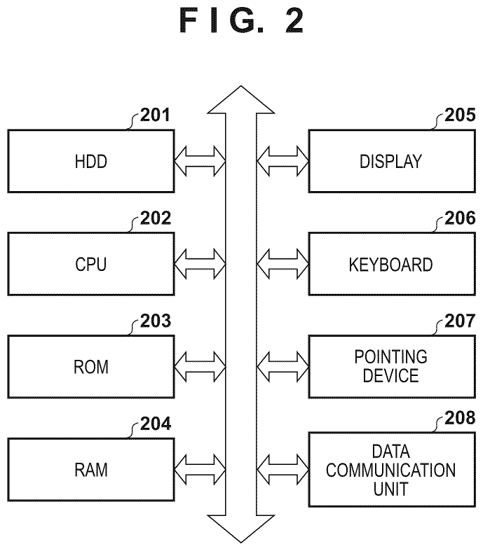

FIG. 2 is a block diagram showing a configuration of the information processing apparatuses 102 and 104. The information processing apparatuses 102 and 104 include a processor (CPU) 202 that executes processing of calculation and the like by executing a program, and a storage unit composed of a hard disk (HDD) 201, a ROM 203, and a RAM 204. Also, the information processing apparatuses 102 and 104 include a display 205, a pointing device 207, and a keyboard 206 as apparatuses that receive and perform inputs and outputs, and include a data communication unit 208 as a collection of controller apparatuses that manage networks and data buses included as hardware. Examples of such information processing apparatuses include personal computers (PCs), smartphones, tablet terminals, and the like. The individual apparatuses can perform data communication with one another via various types of controllers and buses inside the information processing apparatuses 102 and 104.

### Functional Blocks of Color Verification System

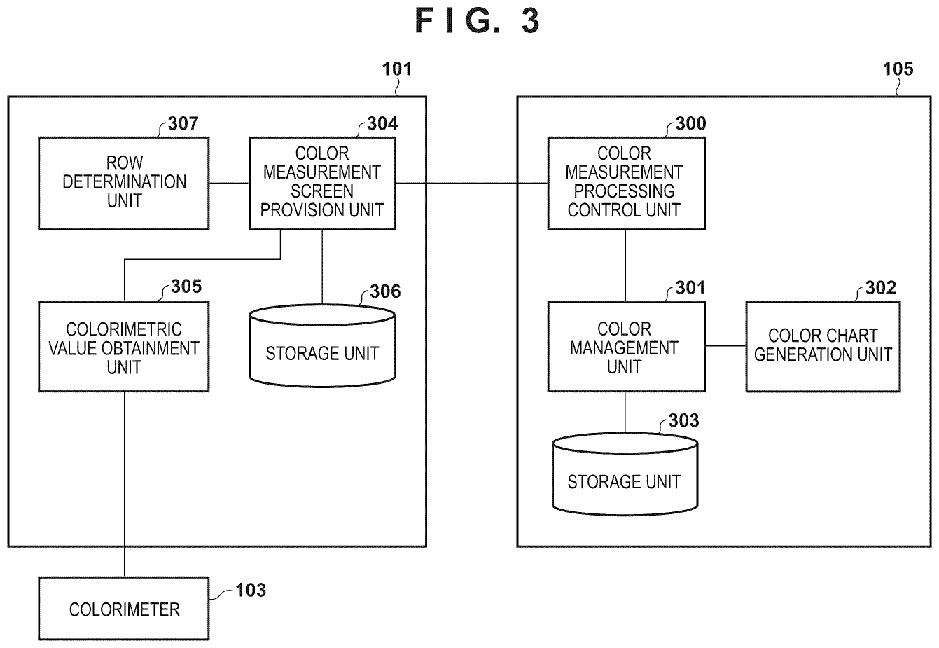

FIG. 3 shows a functional block diagram realized by the information processing apparatus 104 and the information processing apparatus 102 that are respectively in the color management system 105 and the color measurement system 101 that compose the color verification system according to the present embodiment. Note that although the information processing apparatus 104 has print-related functions, such as printing of a color chart, FIG. 3 shows functions related to color management, and functions related to image formation are omitted therein. Each functional block shown in FIG. 3 is realized by each of the CPUs 202 in the information processing apparatuses 102 and 104 executing a program.

A color measurement processing control unit 304 communicates with a color management unit 301 and controls various types of color measurement processing in accordance with an operation performed by a user via a color measurement screen 300. A row determination unit 307 accepts setting values and colorimetric values from the color measurement processing control unit 304 as inputs, and determines to which row in the color chart the colorimetric values pertain. Although the details will be described later, the setting values include, for example, reference values of respective patches in the color chart, and the number of pages, the number of rows, and the number of columns of the color chart. The setting values may be held in a storage unit 306 and obtained via the color measurement screen 300.

A colorimetric value obtainment unit 305 communicates with the colorimeter 103, instructs the colorimeter 103 to perform color measurement, and receives colorimetric values from the colorimeter 103. Also, the colorimetric value obtainment unit 305 receives inputs from a button which is provided on the colorimeter 103 and which is used to detect the start and end of color measurement. The structure of the colorimeter 103 will be described later. The storage unit 306 holds setting values necessary for the color measurement processing.

A color measurement screen provision unit 300 provides an accessing terminal apparatus or the like with a screen for an operation of color measurement on the color chart that uses the colorimeter 103 (a color measurement screen). The color measurement screen provision unit 300 can provide, for example, a non-illustrated web server operating on the information processing apparatus 104 with the color measurement screen in accordance with a URL designated by a browser. The browser that has displayed the color measurement screen can accept an operation performed via a pointing device and a keyboard. Note that in the present embodiment, the browser may not be an independent application, and may be, for example, embedded in a program that realizes the color measurement processing control unit 304.

The color management unit 301 manages processing related to color management executed by the information processing apparatus 104, such as calibration and profile generation. Also, it transmits a command for printing of a color chart necessary for color management to the image forming apparatus 107. A storage unit 303 holds setting values included in the color management unit 301. A color chart generation unit 302 generates a color chart in response to an instruction from the color management unit 301. FIG. 4 is a diagram for describing the structure of the colorimeter 103. The colorimeter 103 has a color measurement unit on a bottom surface thereof, and reads the colors of color patches on a color chart by reading in the reflection of emitted light from the color measurement unit. The colorimeter 103 has a button 401 on a side surface thereof. The button 401 is mainly used by the colorimetric value obtainment unit 305 and the information processing apparatus 102 to detect the start and end of color measurement performed by the colorimeter 103. For example, color measurement is performed while the user is depressing the button 401; in a case where the user has stopped depressing the button 401, color measurement is ended, and the colorimeter 103 transmits the values obtained through color measurement to the colorimetric value obtainment unit 305. Also, the colorimeter 103 can transmit, to the colorimetric value obtainment unit 305 of the color measurement system 101, a signal related to a state indicating whether the button 401 is currently depressed, separately from the values obtained through color measurement.

The colorimeter 103 has an LED color-producing unit 400 on an upper part thereof. When some sort of error has occurred, such as when color measurement has failed, the colorimeter 103 notifies the user of the occurrence of the error by causing an LED to produce a color (emit light) via the LED color-producing unit 400. Note that in color production by LEDs, a variety of colors and chronologically sequential patterns of colors can be produced; therefore, the colorimeter 103 can present a plurality of types of errors by combining colors and patterns. Note that regarding the structure of the colorimeter 103, the colorimeter 103 may be an automatic colorimeter as long as it has similar functions, an input via the button 401 may be, for example, an input via a touch panel or a sound, and the shape thereof is not limited.

### Color Measurement Screen

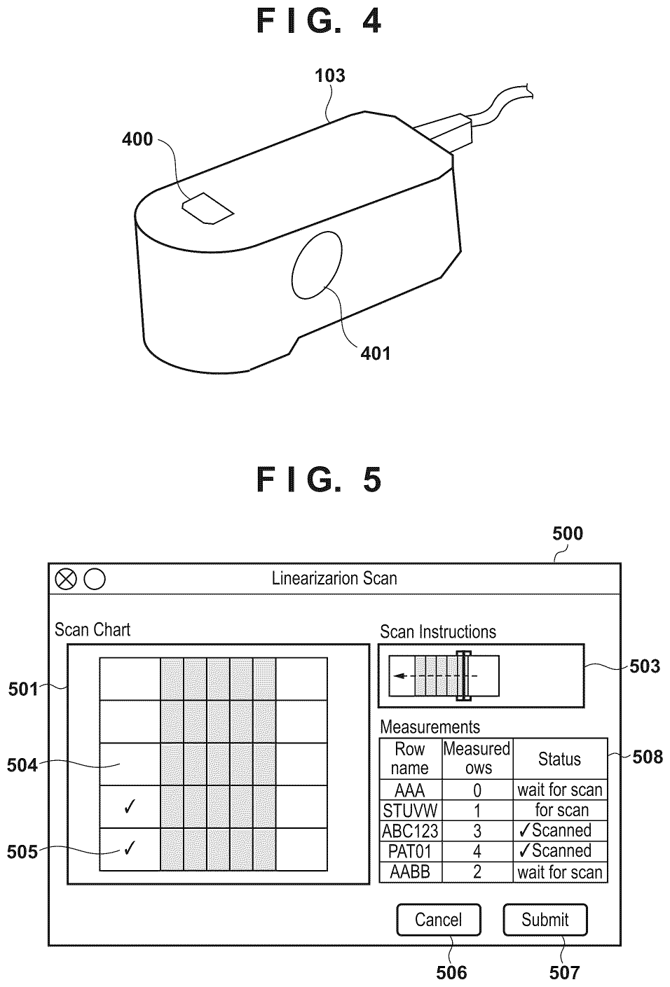

FIG. 5 is a schematic diagram showing an example of a color measurement screen 500 that is provided by the color measurement screen provision unit 300 in the information processing apparatus 104.

The color measurement screen 500 is an example of a remote user interface of the print controller that operates on the information processing apparatus 104. The color measurement screen 500 can be opened by designating a uniform resource locator (URL) of the print controller on a browser of the information processing apparatus 102 or the like. The color measurement screen provision unit 300 can provide the color measurement screen 500 not only to the information processing apparatus 102 via the browser, but also to information processing apparatuses that are connected via a network, including the information processing apparatus 104, and the color measurement screen 500 can be displayed and operated on these information processing apparatuses. The color measurement screen 500 includes a color chart colorimetry status 501, scan instructions 503, a colorimetry status 508, a transmission button 507, and a cancel button 506. A color chart is composed of a color patch array in which a plurality of rows that each include a plurality of color patches aligned in series are aligned in parallel. Color measurement is based on the premise that it is performed on a row-by-row basis. Immediately after the user has started color measurement on the color chart is a state where color measurement has not been performed with respect to any row, and thus an unfinished color measurement icon 504 is displayed with respect to every row. Upon completion of color measurement in one row, the colorimetry status of the row in which color measurement has finished is changed from unfinished color measurement to finished color measurement. In accordance with such a change in the colorimetry status, the icon showing the colorimetry status of the pertinent row is changed from the unfinished color measurement icon 504 to a finished color measurement icon 505. Note that instead of displaying the unfinished color measurement icon 504, the finished color measurement icon 505 may be hidden. In a case where the user has performed color measurement in the same row several times, the finished color measurement icon 505 of that row remains in a displayed state, and the number of times color measurement has been performed in the colorimetry status 508, which will be described later, increases. Note that the colorimetry status and the number of times color measurement has been performed may together be referred to as a state of color measurement.

The scan instructions 503 display a bar indicating the movement of the colorimeter 103 in the row in which color measurement is currently performed from left to right, or from right to left, in accordance with a color measurement operation of the colorimeter 103.

The colorimetry status 508 displays the number of times color measurement has been performed and the colorimetry status, that is to say, the state of color measurement, for each row of patches in the color chart. The display indicating unfinished color measurement as the colorimetry status (e.g., waiting for scan) and the display indicating finished color measurement (scanned) are switched in accordance with the colorimetry status.

In a case where the transmission button 507 has been pressed, an instruction for completing the color measurement processing is issued to the color measurement processing control unit 304 in response. Accordingly, the color measurement processing control unit 304 completes the color measurement processing, and issues a command for executing color management processing in the color management system. In coordination with the colorimetry status 508 and the color chart colorimetry status 501, the transmission button 507 may be grayed out and placed in a non-pressable state until every row has been scanned at least once. Alternatively, the color measurement processing may be completed and the color management processing may be executed, even during a scan, in response to pressing of the transmission button 507 without graying out the transmission button 507. In a case where the cancel button 506 has been pressed, the color measurement processing is stopped. To achieve coordination with the colorimetry status 508 and the color chart colorimetry status 501, it is sufficient to determine whether every row has been scanned at least once by referring to information indicating the colorimetry status, which serves as the basis of display thereof.

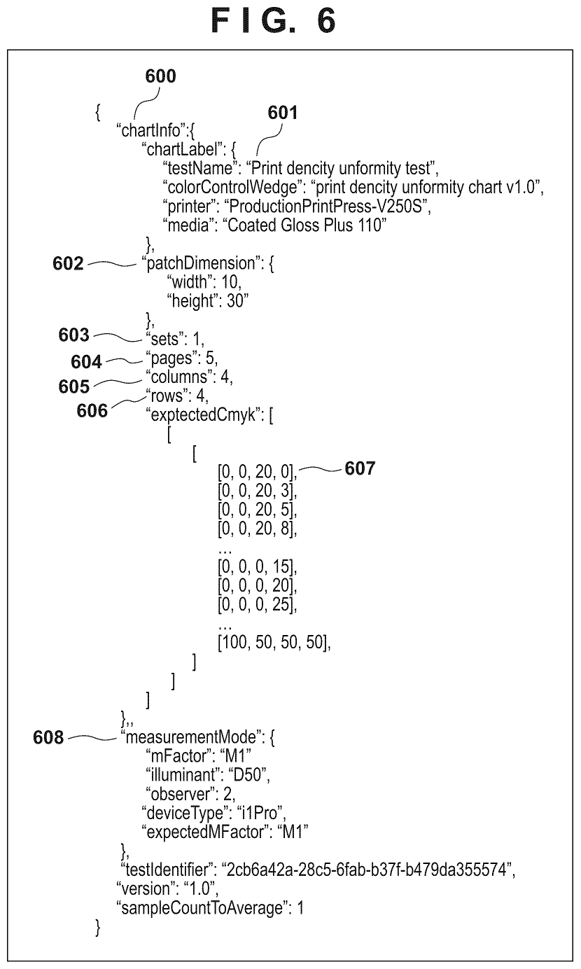

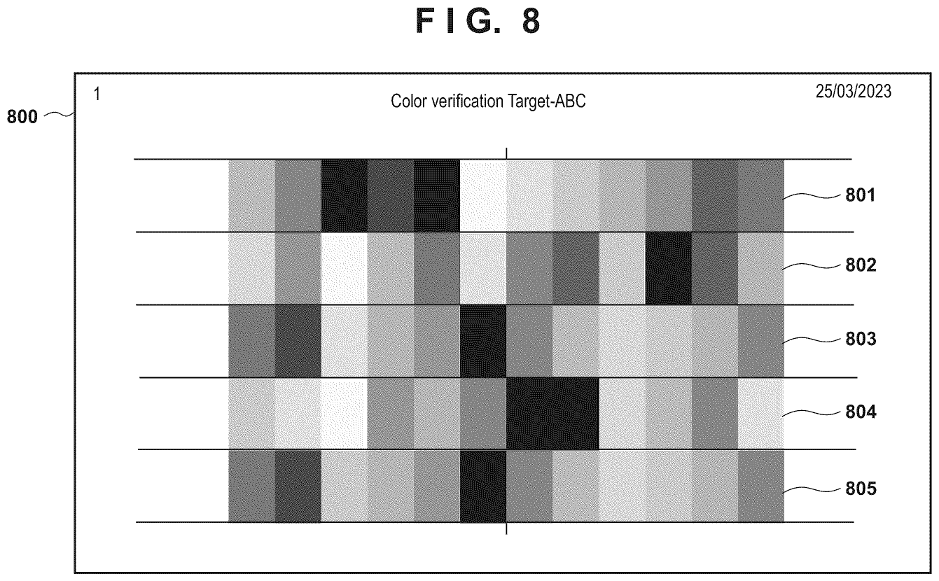

FIG. 6 shows examples of setting values that the color measurement processing control unit 304 obtains from, for example, the color management unit 301 when initializing the color measurement processing. A character string 600 indicates setting values. The present setting values are paired with a color chart that is exemplarily shown in FIG. 8, and include data necessary for the color measurement processing. The setting values are generated at the same time as generation of the color chart by the color chart generation unit 302. Alternatively, conversely, the color chart generation unit 302 may generate the color chart in line with the setting values.

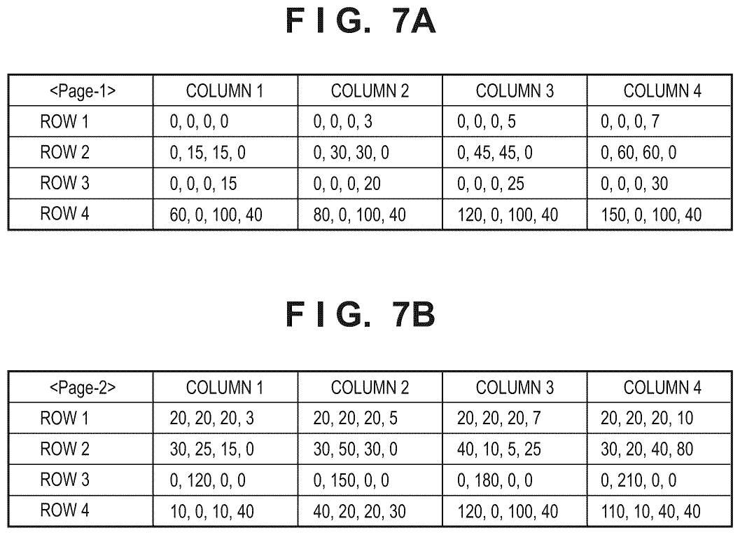

A character string 601 is metadata of the color chart. The metadata of the color chart is, for example, a color chart name, the specifications of color standards of the color chart, a name of a printer that has printed the color chart, and a name of a sheet used in printing of the color chart. A character string 602 indicates a size of the color chart in terms of a height and a horizontal width. A character string 603 is the number of copies of the color chart. A character string 604 is the number of pages of the color chart. The number of columns 605 indicates the number of columns of color patches in one page of the color chart. The number of rows 606 indicates the number of rows of color patches in one page of the color chart. In the present embodiment, the number of columns 605 and the number of rows 606 are referred to as a patch layout. Reference values 607 indicate reference values in one page of the color chart. The reference values may be values which have been determined for the respective color patches, and which indicate the colors of the corresponding color patches. Therefore, the reference values 607 are provided in accordance with the color patch array in the color chart on one page. In a case where the color chart exists across a plurality of pages, the reference values 607 exist on a page-by-page basis. When initializing the color measurement processing, the reference values 607 are arranged in accordance with the number of columns 605 and the number of rows 606, and the matrices shown in the tables of FIG. 7A and FIG. 7B are generated. The table of FIG. 7A represents the matrix of reference values on the first page, and the table of FIG. 7B represents the matrix of reference values on the second page; as the values of the number of columns 605 and the number of rows 606 indicate four columns and four rows, these matrices are 4×4 matrices. The number of rows and the number of columns are numbers that conform with a layout of the color chart; for example, in the case of the chart on the screen shown in FIG. 5, 5×5 matrices are used.

In the color measurement system, an arbitrary threshold is generally set with respect to a reference value, and if the absolute value of the difference between a value obtained through color measurement and a reference value falls under a threshold, it is determined that the value obtained through color measurement, which acts as a detected value, is within a range of the reference value. A character string 608 indicates various types of values of a color measurement mode. The color measurement mode includes values of mFactor that is set on the colorimeter 103, illuminant, a field of view, a device type of the colorimeter, mFactor that is expected based on a reference value, and so forth. Note that mFactor indicates a measurement illumination condition under the standards of the International Organization for Standardization (ISO).

### <Description of Color Chart>

FIG. 8 shows an example of a color chart. A color chart 800 is an example of a color chart that has been generated by the information processing apparatus 104 and printed by the image forming apparatus 107. The color chart 800 is composed of five rows (801, 802, 803, 804, and 805). In each of the five rows, a layout of color patches in the color chart can be set arbitrarily. For example, in a case where the darkness and lightness of each color (CMYK) of the image forming apparatus are to be checked, a layout is generated by making a gradation of each color on a row-by-row basis and printed so as to facilitate visual recognition by human eyes. Also, in order to check whether density unevenness has occurred on one page due to physical non-uniformity of toner that occurs in accordance with a state of the image forming apparatus, there is also a layout for printing a pattern of color patches of the same color at a plurality of locations in a plurality of rows. Note that in a case where colorimetric values do not fall within a permissible range relative to reference values even if the same color patches have been printed on one page, the system and the user can confirm that density unevenness has occurred. As a layout can be set arbitrarily in accordance with a purpose as stated earlier, there are a variety of combinations of color patches.

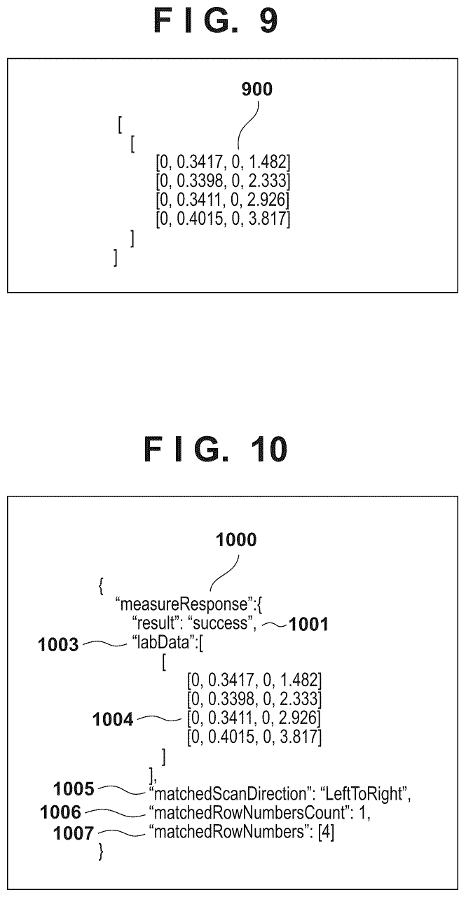

FIG. 9 is a diagram showing examples of colorimetric values obtained by performing color measurement on a color chart with use of the colorimeter 103. When color measurement has been performed in a row on a color chart using the colorimeter 103, the colorimeter 103 returns, to the colorimetric value obtainment unit 305, data obtained through color measurement in a predetermined color system with respect to each of the color patches composing the row of the color chart that has been read. The predetermined color system includes one of the formats of RGB, CMYK, and L*a*b* (which may be referred to as Lab, lab, or the like in the present embodiment), for example. Based on the received colorimetric data, the colorimetric value obtainment unit 305 generates colorimetric values shown in FIG. 9. Colorimetric values 900 are examples of numerical representations of the four color patches for which color measurement has been performed.

FIG. 10 is an example of a colorimetric result generated by the color measurement processing control unit 304. A colorimetric result 800 includes a result indicating whether a row determination has succeeded or failed, which is generated by the row determination unit 307, colorimetric values generated by the colorimetric value obtainment unit 305, a color measurement direction, and a row number. A character string 1000 included in the example of the colorimetric result indicates that it represents the colorimetric result. A color measurement success or failure 1001 shows whether color measurement has succeeded or failed; in the figure, it indicates a success. A color system 1003 indicates to which color system, such as RGB, CMYK, and lab, the values obtained from the colorimeter 103 and the colorimetric value obtainment unit 305 belong. Colorimetric values 1004 indicate colorimetric values obtained from the colorimetric value obtainment unit 305. A color measurement direction 1005 indicates the result of specification of a color measurement direction in relation to a row of color patches; in the figure, it has been specified that color measurement has been performed from left to right. A count of row numbers 1006 indicates the count of the row numbers estimated by the row determination unit 307. A row number arrangement 1007 indicates an arrangement of the row numbers estimated by the row determination unit 307. Note that there are cases where the row determination unit 307 returns a plurality of rows as a determination result in relation to a colorimetric result of one row, such as a case where one page includes a plurality of same color patches, for example. For example, in a case where the row determination unit 307 has returned two rows as the measurement result, the count of row numbers 1006 stores “2”, and the row number arrangement 1007 stores two row numbers. Note that the count of row numbers may be referred to as the number of rows.

### <Description of Flow of Processing for Case Where Color Measurement is Performed>

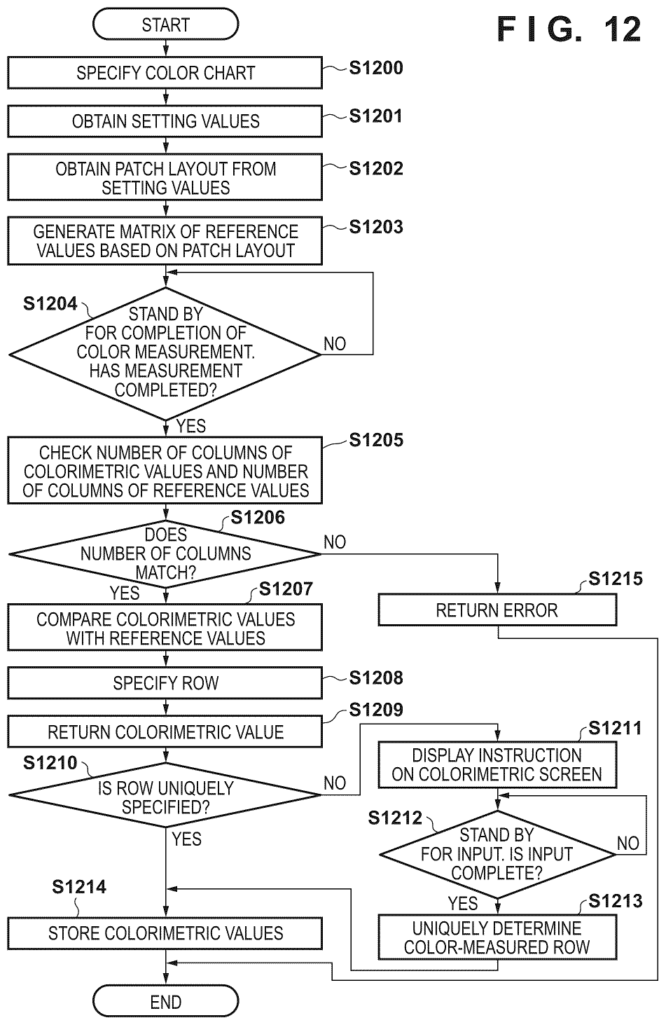

FIG. 12 is a flowchart diagram showing a flow from color measurement on a color chart to row determination. After the execution of printing of a color chart necessary for processing of color management, such as color verification and calibration, the present flowchart is started when the user has issued an instruction for starting color measurement on a non-illustrated screen. Also, in general, the user has the aforementioned printed color chart at hand, and the user performs color measurement on the color chart with use of the colorimeter 103. The following processing is realized by the CPUs 202 of the information processing apparatuses 102 and 104 executing a program loaded in a storage unit, and FIG. 12 shows a procedure of this program. The information processing apparatuses 102 and 104 that are described as main executors of each process specifically denote their CPUs.

The color management unit 301 of the information processing apparatus 104 specifies a color chart necessary for color management in accordance with, for example, a user's designation or an advanced setting, and proceeds to step S1201 (step S1200). For example, in a case where color verification targeting a color standard such as FOGRA and GRACOL is to be performed, a color chart of a designated color standard is specified. Not only a color chart that is standard for the industry, but also a color chart with a layout that has been arbitrarily generated by the user, can be specified. The color chart may have been generated by the color chart generation unit 302 in accordance with designated specifications. The color measurement processing control unit 304 is notified of information of the specified color chart via color measurement screen information provided by the color measurement screen provision unit 300 (information of the color measurement screen 500). Also, in a case where a print instruction has been issued, the specified color chart is printed by the image forming apparatus 106.

The colorimeter 103 obtains setting values that are equivalent to the color chart specified in step S1200 via the colorimetric value obtainment unit 305 of the information processing apparatus 102, and proceeds to step S1202 (step S1201). Specifically, in step S1201, the colorimetric value obtainment unit 305 sets, on the colorimeter 103, the settings necessary for color measurement that are included in the setting values associated with the specified color chart. The setting values include, for example, a layout of color patches, reference values of the respective color patches, and the like. The colorimeter 103 reads the color chart and performs color measurement on each color patch in accordance with the setting values. Note that as the setting values of the color chart are associated with the color chart, they may be generated together with the color chart, provided to the color measurement processing control unit 304 via the color measurement screen provision unit 300, and then passed to the colorimetric value obtainment unit 305.

The color measurement processing control unit 304 of the information processing apparatus 102 obtains a patch layout from the setting values, and proceeds to step S1203 (step S1202). Based on the obtained patch layout, the color measurement processing control unit 304 of the information processing apparatus 102 generates a matrix of reference values by arranging reference values included in the setting values, and proceeds to step S1204 (step S1203). The color measurement processing control unit 304 of the information processing apparatus 102 stands by for completion of color measurement by the user (step S1204). When the user has completed the color measurement on each patch arranged in one row in the color chart with use of the colorimeter 103, processing proceeds to step S1205; while the color measurement is yet to be completed, the color measurement processing control unit 304 keeps standing by (step S1204). It is permissible to adopt a configuration in which the color measurement processing control unit 304 is notified of the completion of color measurement via, for example, an operation on the button 401 of the colorimeter 103.

Upon completion of color measurement, the color measurement processing control unit 304 obtains colorimetric values from the colorimeter 103 via the colorimetric value obtainment unit 305, compares the number of columns of the colorimetric values with the number of columns of the color chart described in the setting values, and proceeds to step S1206 (step S1205). The color measurement processing control unit 304 determines whether the number of columns of the reference values and the number of columns in the result of color measurement match. In a case where the numbers of columns match, processing proceeds to step S1207, whereas in a case where the numbers of columns do not match, processing proceeds to step S1215 (step S1206). In a case where the numbers of columns match, the color measurement processing control unit 304 compares a colorimetric value with a corresponding reference value on a per-color patch basis, and proceeds to step S1208 (step S1207). In step S1207, the color measurement processing control unit 304 compares the colorimetric values with the reference values of each row included in the matrix of reference values generated in step S1203. For example, when the layout of the color chart included in the setting values is 4×4, the measured values corresponding to one row that has been measured are compared with each of four rows of reference values on a per-color patch basis. Furthermore, the order in which reference values are aligned in one row may be reversed, and the reference values may be compared with the measured values of the respective patches, that is to say, the differences therebetween may be obtained. In this case, when the layout is 4×4, the measured values are compared not only with each of four rows of reference values, but also further with each of four rows of reference values in the reverse order, on a per-color patch basis.

Then, based on the result of this comparison, the row determination unit 307 estimates a row with the smallest value differences as a row measured by the user (also called a color-measured row), and proceeds to step S1209 (step S1208). The row that has been estimated as a measured row (also referred to as a candidate row) may be specified by, for example, a row number or the like that has been determined based on the setting values of the color chart. Here, the row with the smallest value differences may be, for example, a row with the smallest average of differences between the measured values of the respective patches and the reference values included in each row of reference values, or may be a row with the smallest variance of such differences. Alternatively, the determination may be made based on multiple criteria; for example, the row with the smallest value differences may be a row with the smallest average among rows with variances equal to or smaller than a predetermined threshold. Furthermore, it is permissible to adopt an estimation method that estimates a row in which the average value and the variance of differences with the reference values of the respective patches are equal to or smaller than predetermined thresholds as a measured row. Also, in this row estimation, in a case where the measured values are compared with each row in which the reference values therein are aligned in a reverse order, the measurement direction is also estimated in addition to the row estimation. Note that even if a row is estimated using the foregoing method, it is possible that a plurality of rows are specified as pertinent rows.

The row determination unit 307 of the information processing apparatus 102 returns a colorimetric result including the estimated row to the color measurement processing control unit 304, and proceeds to step S1210 (step S1209). The color measurement processing control unit 304 of the information processing apparatus 102 checks the count of matching rows in the received colorimetric result, and determines whether the row in the colorimetric result can be uniquely specified. A case where the row can be uniquely specified may be, for example, a case where the number of estimated rows is one. In a case where the row can be uniquely specified, processing proceeds to step S1214, whereas in a case where the row cannot be specified, processing proceeds to step S1211 (step S1210). In a case where the estimated row can be uniquely specified, the color measurement processing control unit 304 of the information processing apparatus 102 returns the colorimetric values, as well as the estimated row number and color measurement direction, to the color management unit 301 via the color measurement screen provision unit 300. Once the measured row number that has been estimated and the colorimetric values have been transmitted to the color management unit 301, the color management unit 301 stores these pieces of information. Also, the color measurement screen provision unit 300 updates the color measurement screen 500 shown in FIG. 5, and displays the finished color measurement icon 505 on the row that has been estimated as the measured row on the color chart colorimetry status 501 thereof (step S1214).

In a case where the measured row cannot be uniquely specified, that is to say, in a case where a plurality of rows are rows that are candidates for the measured row, the color measurement processing control unit 304 of the information processing apparatus 102 displays, on the color measurement screen 500, a message for causing the user to select one row from among these rows that are candidates (step S1211). Although the color measurement processing control unit 304 may directly display this message, it is also possible to cause the color measurement screen provision unit 300 to display this message. In this case, the color measurement processing control unit 304 transmits the colorimetric values, as well as the plurality of row numbers and the color measurement direction that have been estimated, to the color measurement screen provision unit 300. The color measurement screen provision unit 300 updates the color measurement screen 500, and adds thereto a message for causing the user to select one row. Furthermore, regarding the estimated row, a frame, a highlight, a color, and the like indicating that this row is a selection candidate may be additionally displayed. As a result, such a message is displayed on the color measurement screen 500. In this way, with regard to the rows that cannot be specified as one row, the user is instructed to select a row in which the user has actually performed color measurement with use of the colorimeter 103. The details of display of the aforementioned message for instructing the user to select a row will be described later. The method of selection by the user may be a selection via an operation that is performed on a mouse pointer using a mouse, a sound input, a touch panel, or the like. This method is not limited in the present embodiment. After the selection instruction has been displayed, processing proceeds to step S1212.

The color measurement processing control unit 304 of the information processing apparatus 102 stands by for a user input, and proceeds to step S1213 after the user input has been completed (step S1211). If the user input has been made, the color measurement processing control unit 304 of the information processing apparatus 102 uniquely specifies the row of the colorimetric result in accordance with this user input, and proceeds to step S1214, which is processing for returning the colorimetric values and the specified color-measured row to the color management unit 301 (step S1213). Note that in a case where it has been determined that the number of columns in the colorimetric result (i.e., the number of patches included in one row) does not match in step S1206, a row cannot be specified, and thus the information processing apparatus 102 returns an error in the row determination to the color measurement screen provision unit 300. Although the color measurement screen provision unit 300 may display an error screen, an error message, and the like in accordance with the content of the returned error, no particular drawing thereof is provided in the present working example. For example, the color measurement screen provision unit 300 may switch to display of another error UI, or may display an icon indicating the error around the pertinent row on the color measurement screen 500, which is one example. Furthermore, it is also possible to, for example, display a pop-up message; regarding the means, no limitation is intended (step S1215).

Note that the color measurement processing control unit 304 may transmit the colorimetric result including the colorimetric values and the estimated row to the color management unit 301 in step S1209, and processing from step S1210 may be executed by the information processing apparatus 104, except for the display of the message and the input made by the user. Alternatively, it is permissible to adopt a configuration in which the information processing apparatus 102 performs control on the colorimeter 103 and the user interface (display and inputting of the color measurement screen and the message), and the information processing apparatus 104 executes other types of processing.

Once the color management unit 301 has obtained the colorimetric values and the row number thereof in the color chart in the foregoing manner, it may execute calibration on the basis of the differences between the reference values and the colorimetric values of the color patches of the measured color chart, and generate a correction matrix to be used in color correction during image formation. Then, by generating an image with use of this correction matrix, the color reproducibility can be maintained at a high level. The same goes for other embodiments.

### <Description of Screen for Case Where User is Instructed to Select Row>

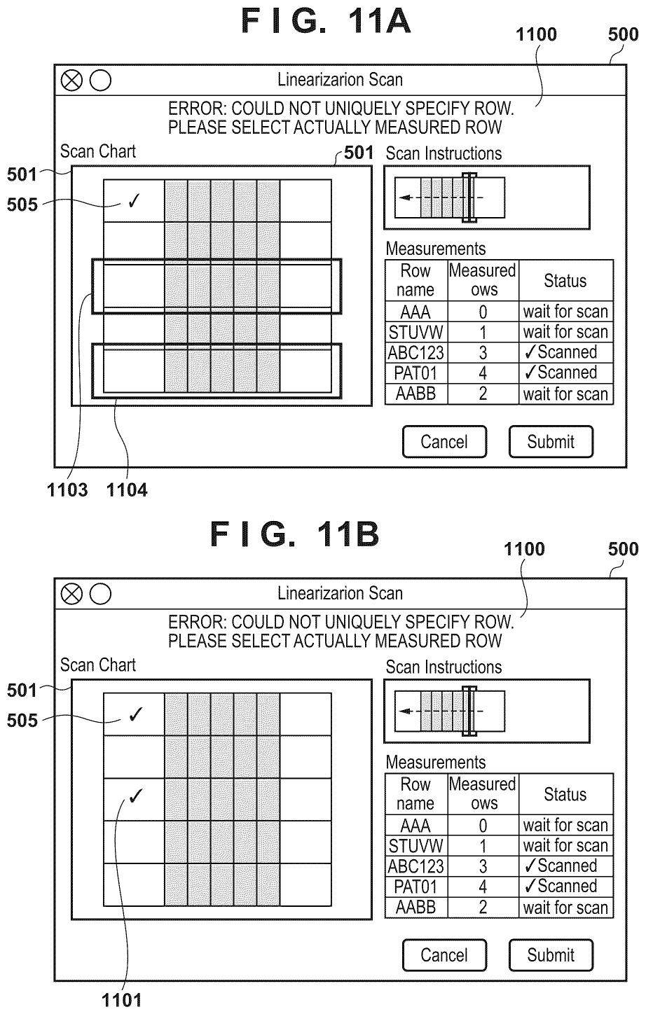

FIG. 11A and FIG. 11B are diagrams showing a state where an instruction to the user about a row selection is displayed on the color measurement screen 500 in a case where the row determination unit 307 has returned a plurality of rows as a determination result as a result of performing color measurement on the color chart. In accordance with an error message 1100 displayed on the color measurement screen 500, the user selects, on the color chart colorimetry status 501, a row in which color measurement has been performed using the colorimeter 103 with use of a mouse, a pointing device, or the like. Note that at the time of the row selection, a user input may be assisted by displaying the rows determined by the row determination unit 307 as candidates on the UI of the color measurement screen 500, as indicated by a frame 1103 and a frame 1104. An example of this case is shown in FIG. 11A. As a result of displaying the candidates, the user can narrow down candidates for a row to be selected, and in addition, the system side can reject a selection of a row other than the candidates, or need not make the rejection. No limitation is intended in the present embodiment. After the user has selected the row, as shown in FIG. 11B, the color measurement screen provision unit 300 displays an icon 1101 on the row selected by the user, similarly to the finished color measurement icon 505, and then hides the error message 1100 that had been displayed.

As described above, the user performs color measurement in one row in the color chart, and the row is determined by comparing the reference values and the colorimetric values of the respective patches arranged in the row. At this time, even in a case where the measured row cannot be uniquely determined, such as a case where the color chart includes rows of the same color patches, it is possible to specify in which row in the color chart the user has performed color measurement without impairing convenience of row determination on the color chart. In this way, for example, when performing color measurement on a color chart in which the same color patches are arranged, color measurement can be realized without impairing, to the extent possible, convenience of a mechanism for making an automatic determination merely using a colorimeter.

### Second Embodiment

In the first embodiment, in a case where a color chart includes the same color patches, a user is caused to select a color chart on which the user has actually performed color measurement with use of a mouse or the like, thereby specifying in which row the measured color patches exist. In the present embodiment, a system that performs color measurement has layout information of a color chart via the color management unit 301. In view of this, in a case where the rows that are above and below the color patch rows estimated as candidates for a measured row (referred to as candidate rows) include color patches different from the color patches of the candidate rows, color measurement is performed with respect to rows that are above and/or below the color patches in the plurality of candidate rows. By using the colorimetric values thereof, the row determination unit 307 and the color measurement processing control unit 304 can estimate in which row in the color chart the user has performed color measurement. Also, if the user is instructed to select a row via the color measurement screen 500, the user's hand needs to switch from the colorimeter 103 to a mouse, thereby inhibiting a smooth color measurement task and impairing convenience. However, if the color-measured row is estimated using the layout information of the color chart that is the measurement target and information of additional color measurement that uses the colorimeter 103, the task to switch to the mouse becomes unnecessary, and thus a further improvement in convenience can be expected. In view of the above, the second embodiment will be described in relation to a method of estimating the color-measured row with use of the layout information of the color chart and information of additional color measurement that uses the colorimeter 103. Note that as the components of the second embodiment are, in large part, the same as those of the first embodiment, a description of the components and processing that are common to the first embodiment is omitted, and only the differences will be described.

### <Description of Screen of Instruction for Color Measurement>

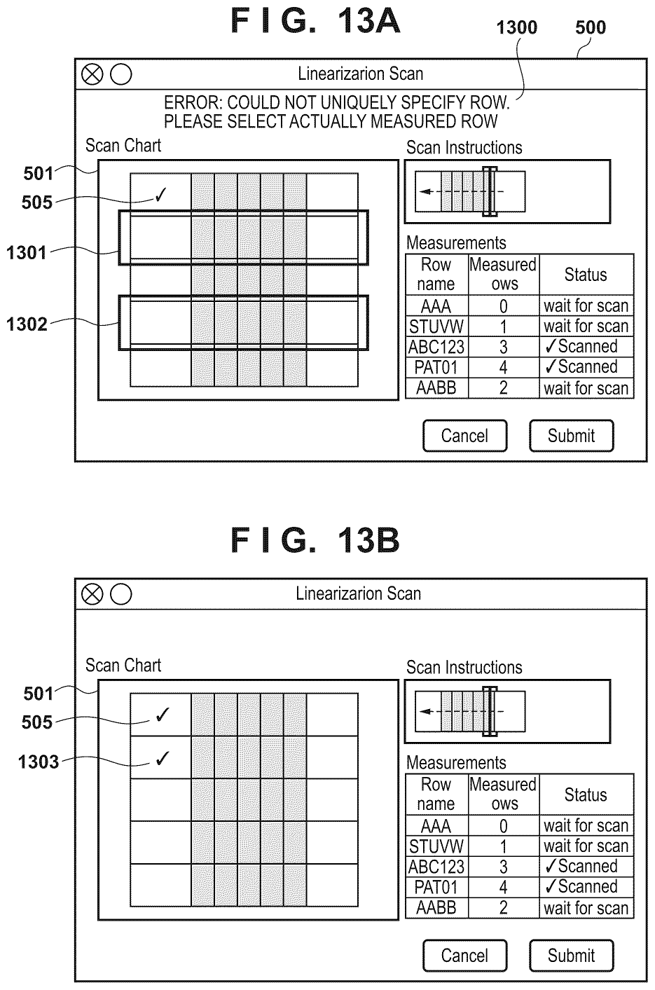

FIG. 13A and FIG. 13B are diagrams showing a state where a message representing an instruction for color measurement is displayed on the color measurement screen 500 (FIG. 13A), and a state where a row has been uniquely specified according to the present embodiment (FIG. 13B), in a case where the row determination unit 307 has returned a plurality of rows as a determination result. Note that in FIG. 13A and FIG. 13B, the same color patches are used as the color patches in a frame 1301 and a frame 1302, which are respectively in the second row and the fourth row from the top on the color chart. Also, although the frame 1301 and the frame 1302 are displayed on the color measurement screen 500 to indicate which row has failed to be specified when displaying the message, there is no problem in not displaying these frames and a method of displaying these frames is not limited in realizing the present embodiment.

In FIG. 13A, in a case where the row determination unit 307 has returned a plurality of rows as a determination result, an instruction to the user about a row selection is displayed on the color measurement screen 500. A character string 1300 is a message for instructing the user to perform color measurement in a row that is below the row in which color measurement has been actually performed. In accordance with the message 1300 displayed on the color measurement screen 500, the user performs color measurement with use of the colorimeter 103. Then, in a case where the color-measured row that was not able to be specified uniquely has been specified as a result of the color measurement performed by the user and later-described processing of the present embodiment, a finished color measurement icon that is similar to the icon 505 is displayed, like an icon 1301 of FIG. 13B. Note that although the displayed message 1300 reads “please measure the row that is below the row that has been actually measured” in FIG. 13A, the row to be measured is not necessarily the row that is below the row that has been actually measured, as will be described using FIG. 15. In view of this, a row variable i, which will be described using FIG. 15, may be applied to the message so that the message reads “please measure the row located “i” rows below the row that has been actually measured”, or the row that is the measurement target may be shown on a chart 501 without showing the row that is the measurement target in the message.

### <Flow of Processing for Case Where Color Measurement is Performed>

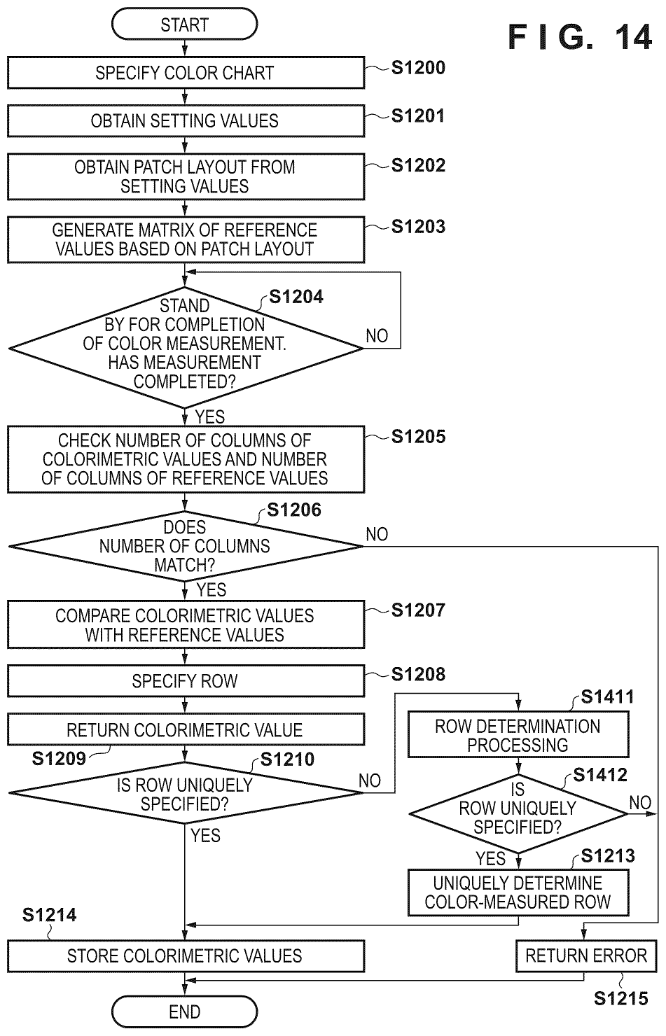

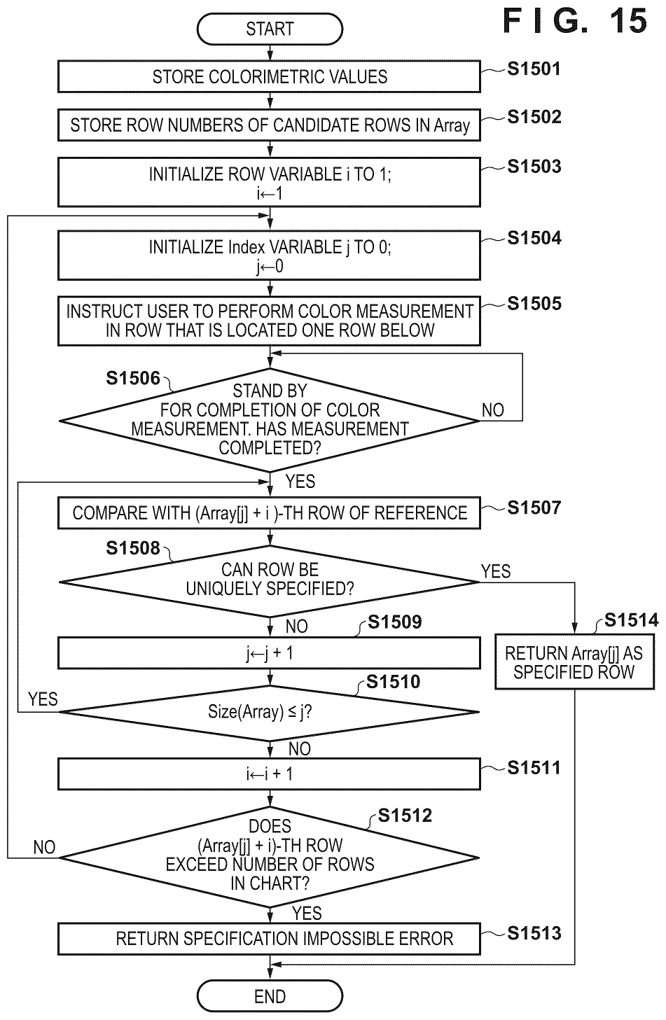

FIG. 14 is a flowchart diagram showing a flow from color measurement on a color chart to row determination, and is related to FIG. 12 of the first embodiment. After the execution of printing of a color chart necessary for processing of color management, such as color verification and calibration, the present flowchart is started when the user has issued an instruction for starting color measurement on a non-illustrated screen. Also, in general, the user has the printed color chart at hand, and the user performs color measurement on the color chart with use of the colorimeter 103. The steps in the flowchart shown in FIG. 14 are, in large part, the same as those of FIG. 12. The same steps are given the same reference signs as in FIG. 12. In the second embodiment, processing of later-described steps S1411 and S1412 is the part that is significantly different from the first embodiment. In view of this, these steps will be described in particular. The following processing is executed by the CPUs 202 of the information processing apparatuses 102 and 104.

Steps S1200 to S1210 are similar to those of FIG. 12 of the first embodiment. In a case where the color-measured row cannot be uniquely specified in step S1210, processing proceeds to step S1411.

The row determination unit 307 of the information processing apparatus 102 executes row determination processing, and proceeds to step S1412 (step S1411). The row determination processing will be described later with reference to FIG. 15. The color measurement processing control unit 304 of the information processing apparatus 102 determines whether the row was able to be uniquely specified. In a case where the row could be uniquely specified, processing proceeds to step S1213. In a case where the row could not be uniquely specified, processing proceeds to step S1215 (step S1412). Step S1213 onward is similar to that of the first embodiment.

### <Details of Row Determination Processing>

FIG. 15 is a flowchart showing the details of the row determination processing executed in step S1411 described above. Processing of step S1411 is performed by the row determination unit 307 of the information processing apparatus 102, and in terms of hardware, executed by the CPU 202 of the information processing apparatus 102.

The row determination unit 307 of the information processing apparatus 102 stores the colorimetric values of the rows that cannot be specified as one row, and proceeds to step S1502 (step S1501). Note that they may be stored into a memory like a RAM, or a disk or a magnetic storage apparatus like an HDD. The information processing apparatus 102 stores a list of row numbers of the aforementioned rows of color patches that failed to be uniquely specified into a variable Array, and proceeds to step S1503 (step S1502).

The variable Array is a one-dimensional array, and the range of indexes thereof is the number of rows that are candidates for the row of color patches for which color measurement has finished. For example, when the number of rows of color patches that are candidates is 2, the indexes of the variable Array is in the range of 0 to 1 and can be denoted by, for example, Array [0 . . . 1]. For example, when the rows that are candidates in step S1502 are the second row and the fourth row in the color chart, the two row numbers indicating these rows are stored into the variable Array. These row numbers are stored in correspondence with the indexes 0 and 1 of the variable Array, respectively; as a result, the information processing apparatus 102 can retrieve them any time. A row variable i is defined to search for a row with a row number that is displaced from a row number stored in the variable Array by the designated number of rows, the row variable i is initialized to 1, and processing proceeds to step S1504 (step S1503). The row variable i denotes a displacement from a row of interest Array [i]. i=1 indicates a row that is below the row of interest. The information processing apparatus 102 defines an index variable j for accessing a value stored in the variable Array, initializes j to 0, and proceeds to step S1505 (step S1504).

For the sake of later description, the row variable i and the index variable j are now explained. The variable j is used to retrieve one row number that could not be uniquely specified from the variable Array. For example, assume that the row numbers 2 and 4 are stored in correspondence with the indexes 0 and 1 of the variable Array, respectively. In this case, 2 can be retrieved from the variable Array when the index variable j is 0, and 4 can be retrieved therefrom when the index variable j is 1. Also, along with an increase in the row variable i from 1 to 2, and then to 3, the row number that is displaced from the row number retrieved from the Array variable by i row(s) can be obtained. For example, the (Array [0]+i)^{th} row number is (2+1), (2+2), and (2+3) for i=1, 2, and 3, respectively. That is to say, the third row, the fourth row, and the fifth row of the color chart can be specified, and the information processing apparatus 102 can obtain the values of color patches therein. Similarly, when the value of the index variable j is 1, along with an increase in the value of the row variable i from 1 to 2, and then to 3, it is possible to specify (4+1), (4+2), and (4+3), that is to say, the fifth row, the sixth row, and the seventh row. Then, the information processing apparatus 102 can obtain the values of color patches in these rows in the color chart. Combining the Array and the variables i and j makes it possible to specify a row of color patches that is displaced from a row that is a candidate for a measured row by the arbitrary number of rows, and allows the information processing apparatus 102 to obtain information of reference values corresponding thereto. Furthermore, the specified reference values are compared with later-described colorimetric values obtained by issuing an instruction to the user, and the row number corresponding to the colorimetric values is specified. This specified row number is the row number that has been specified by the value of Array [j]+i, and the row number indicated by Array [j] can be specified as the measured row. That is to say, in the present embodiment, color measurement is performed not only in a row that is a candidate for the measured row, but also in a row that is distanced from that row by the designated number of rows, and a comparison is made with the reference values of the pertinent rows; in this way, one row can be specified from among the candidates for the measured row. It is assumed here that a row indicated by Array [j] is referred to as a row of interest, and a row indicated by Array [j]+i is referred to as a row of reference.

The information processing apparatus 102 instructs the user to perform color measurement in the row that is located one row below via the color measurement screen 500 shown in FIG. 13A, and proceeds to step S1506 (step S1505). The row that is located one row below is the row that is located below the row of reference for which color measurement was performed last. Regarding the instruction at this time, the color measurement screen 500 may display the row that is the color measurement target using a frame, a highlight, an icon, or the like, together with a message. Also, the message may be changed in accordance with the row that is the color measurement target. The information processing apparatus 102 stands by for completion of the color measurement that is performed by the user with use of the colorimeter 103 on the color measurement screen 500; after the color measurement has been completed, processing proceeds to step S1507 (step S1506). Note that as the color measurement screen 500 is provided by the color measurement screen provision unit 300, processing of steps S1505 and S1506 may be executed by, for example, the color management unit 301 in accordance with an instruction from the information processing apparatus 102 via the color measurement screen provision unit 300.

In step S1507, the information processing apparatus 102 retrieves the row number stored as the j^{th} in the variable Array as the row of interest. Then, the reference values of the (Array [j]+i)^{th} row, that is to say, the row of reference, included in the setting values of the color chart obtained from the color management unit 301, are compared with the colorimetric values of the row of reference obtained through the color measurement performed by the user (step S1507). Thereafter, processing proceeds to step S1508.

In step S1508, the information processing apparatus 102 determines whether a row can be uniquely specified through the comparison. In a case where the row can be uniquely specified, processing proceeds to step S1514, whereas in a case where the row cannot be specified, processing proceeds to step S1509 (step S1514). A case where the row can be uniquely specified is a case where the colorimetric values match the reference values of the row of reference, and the match may encompass a state where the differences therebetween are equal to or smaller than a predetermined value. The state where the differences are equal to or smaller than the predetermined value may be a state where the average value or the variance of the differences is equal to or smaller than a predetermined value.

The information processing apparatus 102 returns the row number Array [j] of the row of interest, which is stored as the j^{th} in the variable Array, as a result of estimation in the row determination, together with a signal indicating that the specification has succeeded, and ends processing (step S1514).

On the other hand, in a case where one color-measured row could not be specified from among the candidates for the color-measured row in step S1508 even through the color measurement in the row of reference that has been additionally performed by the user, one is added to the index variable j (step S1509). In this way, another row that is a candidate is set as a new row of interest, and is placed in a state where it can be retrieved by the information processing apparatus 102, and processing proceeds to step S1510. The information processing apparatus 102 determines whether the number stored in the variable Array is equal to or smaller than the index variable j (step S1510). The number stored in the variable Array is the number of elements in the one-dimensional Array, and can also be said to be the size of the variable Array because the variable Array is one-dimensional. In an example in which the array variable is Array [0 . . . max], the size of the variable Array is the value of max+1. In a case where the number stored in the Array is equal to or smaller than the index variable j, it means that the index variable j has exceeded the upper limit value of the indexes of the variable Array. In this case, processing proceeds to step S1511. On the other hand, in a case where the index variable j has not exceeded the upper limit value of the indexes of the variable Array, the information processing apparatus 102 can retrieve a row number that is a candidate from the variable Array, and thus proceeds to step S1507. In step S1507, with regard to the new row of interest, the reference values and the measured values of the corresponding row of reference are compared. On the other hand, in step S1511, the information processing apparatus 102 adds one to the row variable i. That is to say, the row of reference is changed from the current row of reference to the row that is further therebelow. Thereafter, processing proceeds to step S1512.

In a case where the row number (row of reference) obtained by adding i row(s) to the candidate row number (row of interest) retrieved from the Array exceeds the number of rows in the color chart, the information processing apparatus 102 attempts to obtain the colorimetric values of a non-existing row from the color management unit 301. Therefore, it is necessary to check whether this exceeding has occurred. The information processing apparatus 102 determines whether the row number of the row of reference obtained by adding i row(s) to the row number of the row of interest that is a candidate, which has been retrieved from the variable Array, exceeds the number of rows in the color chart (step S1512). In a case where the row number of the row of reference obtained by adding i row(s) to the row number of the row of interest that is a candidate, which has been retrieved from the variable Array, exceeds the number of rows in the color chart, the information processing apparatus 102 proceeds to step S1513 and executes error processing. This is a case where specification of one row has failed even if every row that is a candidate has been set as the row of interest and color measurement has been performed in every row of reference that can be a target. In view of this, in a case where row number of the row of reference exceeds the number of rows in the color chart, the information processing apparatus 102 returns a value including a signal representing an error that indicates a failure in specification of the row number of the measured row, and ends processing (step S1513). On the other hand, in a case where it has been determined that the row number of the row of reference does not exceed the number of rows in the color chart in step S1512, processing proceeds to step S1504. In step S1504, the row of interest is restored to the first row number stored in the variable Array, and subsequently, processing for comparing the reference values and the measured values of the next row of reference, Array [j]+i, is repeated.

In the foregoing manner, a row in a color chart in which the user has performed color measurement is specified by comparing the reference values and the colorimetric values of the respective patches that are arranged in one row. At this time, in a case where one row cannot be specified because, for example, the color chart includes rows with the same color patches, color measurement is performed in a row other than a candidate row; if the correspondence with the reference values has been confirmed with respect to a plurality of rows, the candidate row is specified as the measured row. Therefore, the user's hand is not required to switch from the colorimeter to the mouse. In the present embodiment, the user performs additional color measurement; accordingly, the color measurement system estimates a row number from the layout of the color chart. This makes it possible to specify in which row in the color chart the user has performed color measurement without impairing convenience in determining the row in the color chart. Note that the present embodiment is a working example in which an instruction for additional color measurement is issued in one direction, namely upward or downward, and a description thereof is omitted. However, it goes without saying that, depending on the situation, this direction is not limited in the present working example, and it goes without saying that the present working example can be realized by an implementation method that incorporates any direction or a combination of both directions because the essence of the present working example does not change either way. It is sufficient that the row variable i has a negative sign in a case where the row of reference is above the row of interest.

### Third Embodiment

In the first embodiment, in a case where a color chart includes the same color patches, a user is caused to select a color chart on which the user has actually performed color measurement with use of a mouse or the like, thereby specifying in which row the measured color patches exist. In general, even in a color measurement system in which color measurement can be performed in any row in a color chart, a user who performs color measurement often performs color measurement on color patches in the color chart from the top or the bottom in order. Considering such a behavior, even in a case where the color measurement system cannot uniquely specify the row in which the user has performed color measurement from the colorimetric values, the color measurement system can estimate in which row the user has performed color measurement from a conceivable behavior. In view of this, in a case where a color chart includes the same color patches, the row determination unit 307 and the color measurement processing control unit 304 can estimate in which one of the rows of the same color patches the user has performed color measurement with use of history information of row numbers for which the user has performed color measurement in the past. If the user is instructed to select a row via the color measurement screen 500, the user's hand needs to switch from the colorimeter 103 to a mouse, thereby inhibiting a smooth color measurement task and impairing convenience. In contrast, if color measurement is performed using the history information, the task to switch to the mouse becomes unnecessary, and thus convenience can be further improved. In view of this, a third embodiment will be described in relation to a method of estimating a color-measured row with use of color measurement history information of the user. Note that as the system configuration and processing of the third embodiment are, in large part, the same as those of the first embodiment, a description that is common to the first embodiment is omitted, and only the differences will be described. Note that the processes that are the same as those in FIG. 12 are given the same reference signs thereas.

### <Color Measurement That Accompanies Storing of History Information>

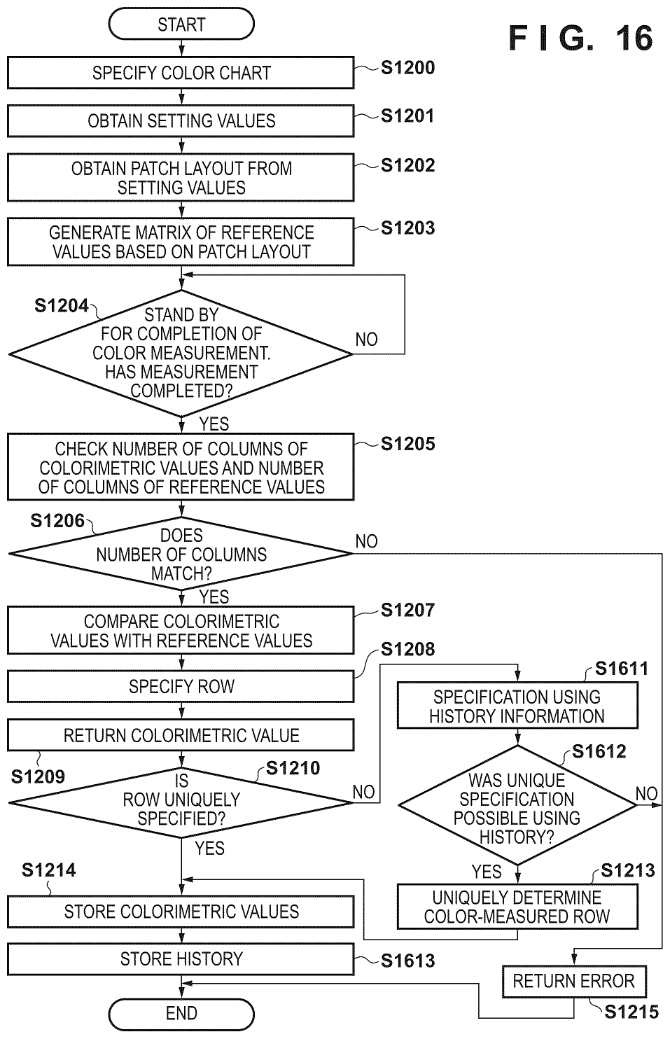

FIG. 16 is a flowchart diagram showing a flow from color measurement on a color chart to row determination, and is related to FIG. 12 of the first embodiment. After the execution of printing of a color chart necessary for processing of color management, such as color verification and calibration, the present flowchart is started when the user has issued an instruction for starting color measurement on a non-illustrated screen. Also, in general, the user has the aforementioned printed color chart at hand, and the user performs color measurement on the color chart with use of the colorimeter 103.

The steps in the flowchart shown in FIG. 16 are, in large part, the same as those of FIG. 12. In the third embodiment, processing of later-described steps S1611, S1612, and S1613 is mainly the part that is significantly different from the first embodiment. The following processing is executed by the CPUs 202 of the information processing apparatuses 102 and 104.

In step S1210, the information processing apparatus 102 checks the count of matching rows in the colorimetric result, and proceeds to step S1611 in a case where a row in the colorimetric result cannot be uniquely specified.

In step S1611, using history information that stores a history of row numbers of rows in which the user has performed color measurement, the information processing apparatus 102 estimates a row in which the user has performed color measurement and which could not to be uniquely specified. Row estimation processing will be described later. After the row estimation processing, processing proceeds to step S1612. In step S1612, the information processing apparatus 102 determines whether a row could be uniquely estimated through the row estimation processing that uses the history information. In a case where the row could be uniquely estimated, the color-measured row is uniquely determined, and processing proceeds to step S1213. In a case where the estimation failed, processing proceeds to step S1215.

In step S1213, using the result of step S1611, the information processing apparatus 102 uniquely determines the row in which the user has performed color measurement from among the rows that were not able to be uniquely specified, and proceeds to step S1214.

In step S1214, the information processing apparatus 102 returns the colorimetric values, the row number, and the color measurement direction to the color management unit 301 by way of the color measurement screen 300 via the color measurement processing control unit 304. Once the measured row number that has been estimated and the colorimetric values have been transmitted to the color management unit 301, the color management unit 301 stores these pieces of information. Also, the color measurement screen provision unit 300 updates the color measurement screen 500 shown in FIG. 5, and displays the finished color measurement icon 505 on the row that has been estimated as the measured row on the color chart colorimetry status 501 thereof. Thereafter, processing proceeds to step S1613.

In step S1613, the information processing apparatus 102 stores the row number of the row in which the user has performed color measurement in the history information. The history information stores a queue or an array; a history of row numbers of rows in which the user has performed color measurement is stored in order therein. For example, in a case where the user has performed color measurement on color patches in the order of the first row, the second row, and the third row, the history information stores values {1, 2, 3} in this order. As another example, in a case where the user has performed color measurement on color patches in the order of the fourth row, the third row, and the second row, the history information stores values {4, 3, 2} in this order. The history information is stored in the storage unit 303. After storing the history information, the information processing apparatus 102 ends processing.

<Processing for Specifying and Estimating Row with Use of History Information>

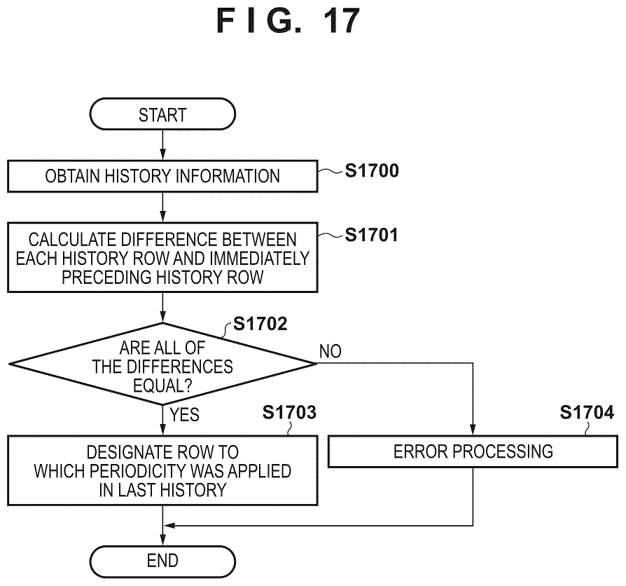

Using a flowchart of FIG. 17, a description is now given of a flow of processing in which the information processing apparatus 102 uniquely estimates a color-measured row in which the user has performed color measurement from among a plurality of rows that are candidates for a color-measured row (candidate rows) with use of the history information in step S1611 of FIG. 16. Note that the information processing apparatus that is described as a main executor of processing is more specifically the CPU 202 thereof.

The information processing apparatus 102 obtains the history information from the storage unit 303, and proceeds to step S1701 (step S1700). The information processing apparatus 102 retrieves two consecutive row numbers from among the row numbers stored in the history information, and calculates the difference therebetween (step S1701). The history information includes the row number for which color measurement has been performed in the order of execution of color measurement. Step S1701 calculates a value by subtracting an older, that is to say, an earlier row number from a newer, that is to say, a later row number, among the two consecutive row numbers. For example, when the history information stores a history {1, 2, 3}, a color measurement history of consecutive row numbers refers to a pair of 3 and 2 and a pair of 2 and 1 that are retrieved from the history information in a backward order. Then, 1 is calculated as the difference in each pair. If all of the differences are equal, that is to say, an equal difference, and the differences are 1, the color measurement system can confirm that the user has performed color measurement on color patches in the color chart in order from the top, on a row-by-row basis. After calculating the differences via the color measurement processing control unit 304, the information processing apparatus 102 proceeds to step S1702. An absolute value of such a difference is a difference between row numbers for which color measurement has been performed, and indicates the direction in which color measurement has been advanced, for example, from top to bottom when it has a positive sign, and from bottom to top when it has a negative sign.

The information processing apparatus 102 determines whether all of the differences in the history information are equal (step S1702). In a case where all of the differences are equal, the next row can be estimated, and thus processing proceeds to step S1703. In a case where at least one difference is different, processing proceeds to step S1704. Also, processing may branch to step S1704 in a case where the history information could not be obtained, or in a case where the difference cannot be calculated because the history information stores only a row number corresponding to one row.

In a case where all of the calculated differences are equal, the color measurement processing control unit 304 of the information processing apparatus 102 stores a value obtained by adding the difference calculated from the history information in step S1701 to the row number for which color measurement was performed last as an estimation result, stores information indicating that processing has succeeded, and ends processing (step S1703). In a case where all of the calculated differences are not equal, as the color measurement processing control unit 304 of the information processing apparatus 102 cannot uniquely specify the row in which the user has performed color measurement, it stores information indicating that processing has failed, and ends processing (step S1704). The information indicating the success or failure of processing serves as a criterion for determination in step S1612.

Note that in step S1703, it is permissible to further determine whether the value calculated by adding the difference calculated in step S1701 to the row number for which color measurement was performed last matches one of the row numbers that are candidates. In a case where the calculated value matches one of the candidates, the calculated value may be set as an estimation result, the estimation may be regarded to have succeeded, and processing may be ended. Meanwhile, in a case where the calculated value does not match any of the candidates, the specification may be regarded to have failed.

Note that the history information may be associated with identification information of the user; the history information that has been stored in association with the identification information of the user who is performing color measurement may be referred to in step S1611, and the history information may be stored in association with the identification information of the user who is performing color measurement in step S1613.

In the foregoing manner, in the present embodiment, a history is referred to, and a measured row that has been measured by the user is specified from among candidate rows on the basis of the periodicity of color-measured rows that are recorded in the history. More specifically, from among candidate rows, a row located at an interval conforming with the periodicity indicated by the history information from a previous measured row, that is to say, a measured row that was specified immediately before the current candidate row, is specified as a new measured row.

As described above, the user performs color measurement in one row in the color chart, and the row is determined by comparing the reference values and the colorimetric values of the respective patches arranged in the row. At this time, even in a case where a row could not be uniquely determined when the color chart includes the same color patches, an inference is made from the user's tendency in color measurement and the history information; in this way, a color-measured row can be uniquely estimated without the user's hand switching to a mouse. Therefore, the color measurement system can specify in which row in the color chart the color measurement has been performed without impairing convenience for the user.

Note that in the present embodiment, based on the premise that at least row numbers corresponding to two rows in which color measurement has been performed consecutively are recorded in the history information, one row is specified from among a plurality of rows that are candidates for a color-measured row. In view of this, for example, in a case where one row number could not be specified in step S1612, processing may branch to step S1211 of FIG. 12 according to the first embodiment and the user may be caused to select a row, instead of issuing an error, so that at least row numbers corresponding to two rows in which color measurement has been performed consecutively are recorded in the history information. In this case, the row selected by the user is also recorded as the history information. In this way, the row numbers of color-measured rows can be reliably recorded as the history information. This leaves the possibility that a color-measured row can be specified using the history information according to the present embodiment in the third row onward.

### Fourth Embodiment

In the first embodiment, when a row of color patches in which the user has performed color measurement cannot be uniquely specified, the information processing apparatus 102 instructs the user to make a section with use of a mouse via the color measurement screen 300. Incidentally, as shown in FIG. 4, the colorimeter 103 includes the button 401 as an operation unit. Furthermore, the colorimetric value obtainment unit 305 can not only obtain, as an event, information indicating whether the button 401 has been depressed, but also execute arbitrary processing in response to the event. If the selection that is made using the mouse in the first embodiment can be replaced with inputting from the colorimeter 103, the user's hand is no longer required to switch from the colorimeter 103 to the mouse, and thus a further improvement in convenience can be expected. In view of this, a fourth embodiment will be described in relation to a method of improving convenience for the user by selecting a row in which the user has performed color measurement on the color measurement screen 300 with use of the colorimeter 103. Note that as the system configuration and processing of the fourth embodiment are, in large part, the same as those of the first embodiment, a description that is common to the first embodiment is omitted, and only the differences will be described.

### <Description of Display of Row Selection Cursor>

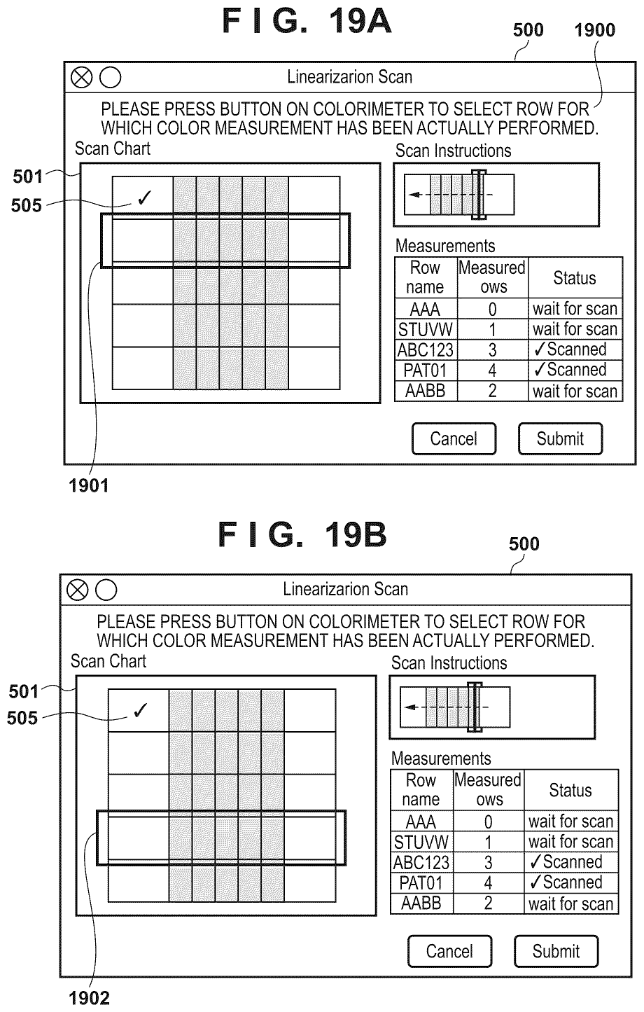

FIG. 19A and FIG. 19B are diagrams showing a case where the user selects, on the color measurement screen 500, a row in which color measurement has been actually performed from among a plurality of rows that have been determined to have a possibility of being color-measured rows by the row determination unit 307.

A message 1900 is a message that suggests the user to select the color-measured row by depressing the button on the colorimeter 103. A frame 1901 is a frame that presents a selectable row; when the user has depressed the button on the colorimeter 103, the row surrounded by the frame 1901 is selected. Furthermore, a frame 1902 is similarly a frame that presents a selectable row; when the user has depressed the button on the colorimeter 103, the row surrounded by the frame 1902 is selected. The color measurement screen 500 alternates between the screens of FIGS. 19A and 19B each time certain seconds have elapsed. The screen alternation realizes a movement between the frames for selection, namely the frame 1901 and the frame 1902; this allows the user to select a row in which the user has actually performed color measurement without disengaging their hand from the colorimeter 103. After the user has completed the color measurement, the message 1900 and the frames 1901 and 1902 are no longer displayed on the screen 500, and color measurement in a row is ended.

Here, the frames 1901 and 1902 or the like are displayed on a plurality of rows which are candidates for a color-measured row, and which have been determined to have a possibility of being color-measured rows by the row determination unit 307. Therefore, in a case where there are three or more pertinent rows, a frame is also displayed for each of these three or more candidates in order.

### <Flow of Processing for Moving Row Selection Cursor>

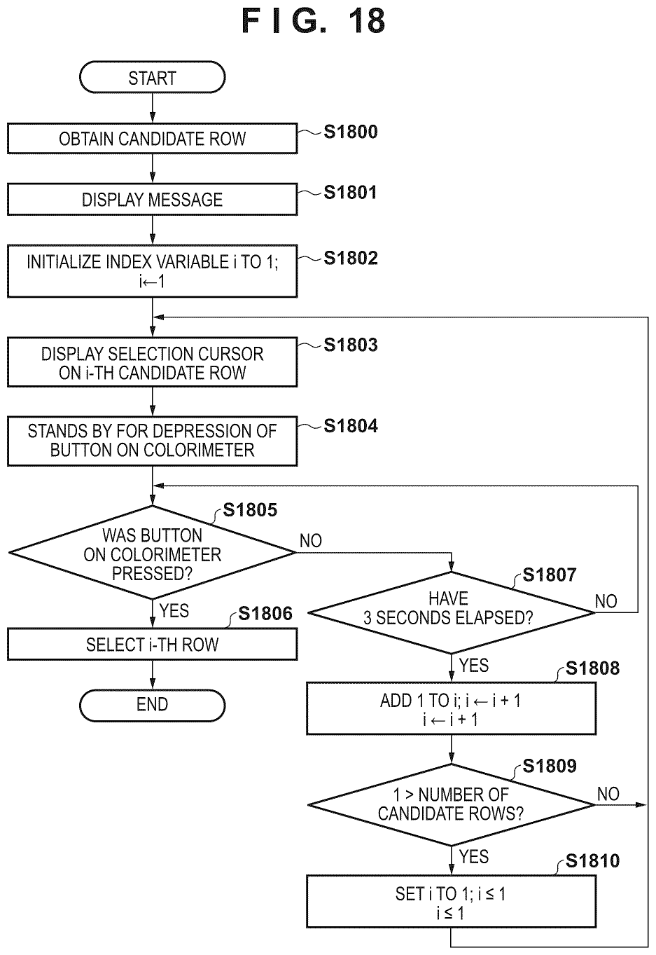

FIG. 18 is a flow diagram showing a flow of processing for a case where the user selects a row in which color measurement has been actually performed on the screen 500 with use of the colorimeter 103. By executing the present processing, a color-measured row can be uniquely specified even in a case where the color chart includes the same color patches and the color measurement processing control unit 304 and the row determination unit 307 cannot determine in which row the user has performed color measurement.

The present processing is started when the row determination unit 307 has returned a plurality of row numbers as color-measured rows to the color measurement processing control unit 304 and the color measurement processing control unit 304 has received the plurality of row numbers. The user performs an operation in accordance with an instruction on the color measurement screen 500. Note that the main executor in FIG. 18 is the color measurement processing control unit 304, and is, in terms of hardware, the CPU 202 of the information processing apparatus 102.

The color measurement processing control unit 304 of the information processing apparatus 102 obtains a list of row numbers that are candidates for a color-measured row from the row determination unit 307, and proceeds to step S1801 (step S1800). The color measurement processing control unit 304 of the information processing apparatus 102 displays, on the color measurement screen 500, the message 1900 representing an instruction for selecting a color-measured row with use of the colorimeter 103, and proceeds to step S1802 (step S1801). Regarding this color measurement screen 500, the color measurement processing control unit 304 may edit the color measurement screen 500 provided by the color measurement screen provision unit 300. Alternatively, it is permissible to adopt a configuration in which the color measurement screen provision unit 300 adds the message 1900 to the color measurement screen 500 in response to the transmission of the obtained list of row numbers to the color measurement screen provision unit 300.

The color measurement processing control unit 304 of the information processing apparatus 102 defines i, which is an index variable for the list of row numbers and which is intended to obtain a candidate row number from the list of candidate row numbers, initializes i to 1, and proceeds to step S1803 (step S1802). The index variable is now described. This index variable is used as follows: for example, in a case where there are three candidate row numbers, the first candidate, the second candidate, and the third candidate are retrieved respectively when i is 1, when i is 2, and when i is 3.

The color measurement processing control unit 304 of the information processing apparatus 102 displays, on the color measurement screen 500, a frame representing a selection cursor on color patches of the i^{th} row number among the candidate rows, and proceeds to step S1804 (step S1803). In step S1803, as the i^{th} row is selected and displayed from among the candidate rows, the candidate rows are sequentially displayed, on a row-by-row basis, as a selected row in accordance with the value of i. The color measurement processing control unit 304 of the information processing apparatus 102 stands by for depression of the button 401 on the colorimeter 103 by the user, and proceeds to step S1805 (step S1804). Note that in practice, information indicating depression of the button 401 is input to the color measurement processing control unit 304 via the colorimetric value obtainment unit 305. The color measurement processing control unit 304 of the information processing apparatus 102 determines whether the button 401 on the colorimeter 103 has been depressed (step S1805). In a case where the button 401 has been depressed, processing proceeds to step S1806, whereas in a case where the button 401 has not been depressed, processing proceeds to step S1807.

The color measurement processing control unit 304 of the information processing apparatus 102 can specify the value of the index variable i at the time by confirming depression of the button 401 on the colorimeter 103. As a result, the user's selection of the i^{th} row candidate can be specified. Based on the specified value of the index variable i, the color measurement processing control unit 304 of the information processing apparatus 102 uniquely determines a color-measured row that had not been uniquely determined (step S1806). At this time, the color measurement processing control unit 304 of the information processing apparatus 102 displays the finished color measurement icon 505 on the row that has been uniquely determined on the color measurement screen 500 on the basis of the result of step S1806, hides the message 1900 and the frame representing the selection cursor, and ends processing.

In a case where the button 401 on the colorimeter 103 has not been depressed, the color measurement processing control unit 304 of the information processing apparatus 102 stands by for a user's input on the colorimeter 103 for three seconds. The color measurement processing control unit 304 of the information processing apparatus 102 determines whether three seconds have elapsed (step S1807). In a case where three seconds have not elapsed, processing proceeds to step S1805, whereas in a case where three seconds have elapsed, processing proceeds to step S1808.

The color measurement processing control unit 304 of the information processing apparatus 102 adds 1 to the index variable i, thereby allowing the cursor frame to move to the next candidate row on the color measurement screen 500 (step S1808). After step S1808, processing proceeds to step S1809. The color measurement processing control unit 304 of the information processing apparatus 102 determines whether the index variable i is larger than the number of candidate rows (step S1809). The present determination is made so as to, in a case where the index variable i is larger than the number of candidate rows, initialize the index variable i again to allow the first row among the candidate rows to be selected again. In a case where the index variable i is larger than the number of candidate rows, processing proceeds to step S1810, whereas in a case where the index variable i is equal to or smaller than the number of candidate rows, processing proceeds to step S1803. In step S1810, the color measurement processing control unit 304 of the information processing apparatus 102 initializes the index variable i to 1 so as to allow a row of the first row number among the candidate row numbers to be selected again as described earlier, and proceeds to step S1803 (step S1810).

Note that the row number that has been specified as the measured row in step S1806 is passed to the color management unit 301 of the information processing apparatus 104, and stored into the storage unit 303. The color measurement screen provision unit 300 may add the finished color measurement icon 505 to the color measurement screen 500 in accordance with this specified row, provide them to the information processing apparatus 102, and cause the information processing apparatus 102 to display them.

By executing the foregoing processing, the selection that is made using the mouse in the first embodiment can be replaced with inputting from the colorimeter 103. When the user is requested to make a selection on the color measurement screen 300, the user's hand need not switch from the colorimeter 103 to the mouse, and thus a further improvement in convenience can be expected.

### Modification Examples

Although processing is executed by two information processing apparatuses, namely the information processing apparatuses 102 and 104, in all of the first embodiment to the fourth embodiment, they may be configured as one information processing apparatus. That is to say, it is permissible to adopt a configuration in which the functional constituents shown in FIG. 3 are provided by one information processing apparatus.

Alternatively, it is permissible to adopt a configuration in which the functions provided by the information processing apparatus 104 are provided by, for example, the image forming apparatus 107.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-022201, filed Feb. 16, 2024 which is hereby incorporated by reference herein in its entirety.

What is claimed is:

1. An information processing apparatus, comprising:
at least one memory storing instructions; and
at least one processor that is in communication with the at least one memory and that, when executing the instructions, cooperates with the at least one memory to execute processing, the processing including
performing, as first specification processing, specification processing of specifying, in a color chart composed of a plurality of rows each including a plurality of color patches, one candidate row that is a candidate for a color-measured row in which a user performed color measurement, based on colorimetric values of the candidate row and reference values of respective color patches in the color chart, and
performing, as second specification processing, specification processing of, in a case where it is not possible to specify only one candidate row in the first specification processing, specifying the color-measured row with use of information other than colorimetric values.

2. The information processing apparatus according to claim 1, wherein
the processing further includes displaying the color chart and an indication of the candidate row included in the color chart, on a display.

3. The information processing apparatus according to claim 2, further comprising
an input unit,
wherein the processing further includes accepting an operation performed by the user via the input unit, and
in the second specification processing, in a case where there are a plurality of candidate rows, one row is specified as the color-measured row from among the candidate rows in accordance with an input performed via the input unit.

4. The information processing apparatus according to claim 1, wherein
in the second specification processing, in a case where there are a plurality of candidate rows, a certain candidate row among the plurality of candidate rows is specified as the color-measured row further on a basis of colorimetric values of another row included in the color chart and reference values of color patches in the other row, the other row being distanced from the certain candidate row by a predetermined number of rows.

5. The information processing apparatus according to claim 4, wherein
in the second specification processing, a certain candidate row among the plurality of candidate rows is specified as the color-measured row in a case where the colorimetric values of the certain candidate row match the reference values of the color patches in the certain candidate row and furthermore the colorimetric values of the other row match the reference values of the color patches in the other row.

6. The information processing apparatus according to claim 1, wherein
the processing further includes recording a history of the color-measured row specified in the second specification processing, and
in the second specification processing, the history is referred to, and based on a periodicity of the color-measured rows recorded in the history, the color-measured row is specified from among the candidate rows.

7. The information processing apparatus according to claim 6, wherein
in the second specification processing, the history is referred to, and based on the periodicity of the color-measured rows recorded in the history, a certain candidate row among a plurality of candidate rows is specified as the color-measured row in a case where the certain candidate row conforms to the periodicity relative to a color-measured row specified in the second specification processing immediately before a current candidate row.

8. The information processing apparatus according to claim 2, further comprising
a color measurement unit configured to be used by the user to perform color measurement on the color chart, the color measurement unit including an operation unit operable by the user,
wherein in the second specification processing, a row selected from among a plurality of candidate rows in accordance with an operation performed via the operation unit is specified as the color-measured row.

9. The information processing apparatus according to claim 8, wherein
in the displaying, each of the candidate rows is further sequentially displayed as the selected row.

10. The information processing apparatus according to claim 1, wherein
in the first specification processing, the colorimetric values are compared with reference values of each row included in the color chart, and a row in the color chart in which the colorimetric values and the reference values match is specified as the candidate row.

11. The information processing apparatus according to claim 10, wherein
a match between the colorimetric values and the reference values encompasses a state where differences between the colorimetric values and the reference values are equal to or smaller than a threshold.

12. The information processing apparatus according to claim 11, wherein
the state where the differences between the colorimetric values and the reference values are equal to or smaller than the threshold encompasses a state where an average value of differences between the colorimetric values and the reference values in respective color patches included in one row is equal to or smaller than a threshold.

13. The information processing apparatus according to claim 11, wherein
the state where the differences between the colorimetric values and the reference values are equal to or smaller than the threshold encompasses a state where a variance of differences between the colorimetric values and the reference values in respective color patches included in one row is equal to or smaller than a threshold.

14. A non-transitory computer-readable storage medium storing a program that, when loaded in and executed by a computer, causing the computer to execute processing, the processing comprising:
performing, as a first specification processing, specification processing of specifying, in a color chart composed of a plurality of rows each including a plurality of color patches, one candidate row that is a candidate for a color-measured row in which a user performed color measurement, based on colorimetric values of the candidate row and reference values of respective color patches in the color chart; and
performing specification processing of specifying, in a case where it is not possible to specify only one candidate row in the first specification processing, the color-measured row with use of information other than colorimetric values.

15. A color verification system, comprising:
an information processing apparatus; and
an image forming apparatus,
wherein the information processing apparatus includes:
at least one memory storing instructions; and
at least one processor that is in communication with the at least one memory and that, when executing the instructions, cooperates with the at least one memory to execute processing, the processing including
performing, as first specification processing, specification processing of specifying, in a color chart composed of a plurality of rows each including a plurality of color patches, one candidate row that is a candidate for a color-measured row in which a user performed color measurement, based on colorimetric values of the candidate row and reference values of respective color patches in the color chart, and
performing, as second specification processing, specification processing of, in a case where it is not possible to specify only one candidate row in the first specification processing, specifying the color-measured row with use of information other than colorimetric values, and
color calibration is performed based on the color-measured row specified by the information processing apparatus, and on a color chart that has been formed as an image by the image forming apparatus.

16. A color measurement method performed by an information processing apparatus, the color measurement method comprising:
specifying, by the information processing apparatus, in a color chart composed of a plurality of rows each including a plurality of color patches, one or more candidate rows that are candidates for a color-measured row in which a user performed color measurement, based on colorimetric values of the one or more candidate rows and reference values of respective color patches in the color chart; and
specifying, by the information processing apparatus, one of the one or more candidate rows as the color-measured row.
